(19) United States
(12) Patent Application Publication
(10) Pub. No.: US 2006/0257842 A1
(43) Pub. Date: Nov. 16, 2006

(54) Cryopreservation media and molecules

(76) Inventors: Jay W. Pettegrew, Pittsburgh, PA (US); Thomas Glonek, Oak Park, IL (US); Richard J. McClure, Pittsburgh, PA (US); Kanagasabai Panchalingam, Monroeville, PA (US)

Correspondence Address: Lesavich High-Tech Law Group, P.C.;Suite 325, 39 S. LaSalle Street, Chicago, IL, 60603, US

(21) Appl. No.: 11/409,395

(22) Filed: Apr. 21, 2006

Related U.S. Application Data
(63) Continuation-in-part of application No. 10/854,894, filed on May 27, 2004.
(60) Provisional application No. 60/474,182, filed on May 29, 2003.

(51) Int. Cl. A01N 1/02; A01N 1/00

(52) U.S. Cl. 435/1.1; 435/2

(57) ABSTRACT

The cryopreservation media utilizes naturally occurring endogenous molecules and their chemical derivatives which act as osmotically active cryopreservative agents as well as molecules which insert into and protect specific regions of cellular membranes, lead to membrane repair, maintain normal cellular levels of energy metabolites, and act as antioxidants. Cryoperserved cells can be returned to a pre- cryopreservation state without damaging the cells resulting in a very high survival rate.

### CROSS REFERENCES TO RELATED APPLICATIONS

This application is a Continuation-In-Part (CIP) of U.S. Application No. 10/854,894, filed May 27, 2004, which claims priority to 60/474,182, filed May 29, 2003, contents of both of which are incorporated by reference.

### FIELD OF THE INVENTION

This invention relates to cryogenic preservation. More particularly it relates to cryogenic preservation of cells and tissues with cryopreservation media and molecules.

### BACKGROUND OF THE INVENTION

“Cryogenic preservation” or “cryopreservation” is a technique that includes lowering a temperature of living biological structures and biochemical molecules to a point of freezing and beyond, for the purposes of storage and future recovery of its pre-frozen, viable, condition. Such biological materials are typically preserved by cooling to a very low temperature (e.g., '80° C. to '196° C.) at which all biological activity, including biochemical reactions that lead to normal cell death are stopped. Cryogenic preservation has been successfully used to preserve spermatoza, blood, tissue samples like tumors and histological cross sections, human eggs (oocyte), human embryos, various types of cells including stem cells, tissue cells, etc.

When living biological materials such as cells are frozen, extracelluar and intracelluar ice formation and dehydration can cause damage to the cells. When cells are cooled, most of the intracellular water leaves the cell and ice forms in the extracelluar spaces. Extracelluar ice can cause mechanical damage to the cells. Dehydration damages the internal components of the cell. However, there is always some water remaining in the cell which leads to intracelluar ice. Intracelluar ice tends to be fatal to cells due to extensive damage to the intracellular components.

The freezing point temperature of intracellular water is lower than extracellular water due to the presence of intracellular osmotically active molecules. In addition, ice has a lower potential energy than liquid water. Therefore, as extracellular water freezes, water moves from the intracellular to the extracellular space leading to cellular dehydration, resulting in damage to membranes, DNA, RNA, and proteins with precipitation of various intracellular molecules. With freezing of intracellular water, the damage is worsened. Cell membrane change is especially severe and is considered the primary site for freezing-related damage.

It is generally accepted that cellular damage during freezing and thawing is caused by intramembrane and intracellular ice crystal formation that is believed to disrupt cellular membranes and destroy the network of intracellular filaments that maintain the cells intact. To avoid this form of damage, cryobiologists cool the cellular samples slowly so that water includeed within the cell membranes or walls has sufficient time to diffuse through the cell membranes or walls before it freezes. However, if the cooling rate is too slow and too much water is drawn out of the cell during the formation of extra-cellular ice, high concentration of salts may be left behind within the cell that denature proteins, damage cellular membranes, and destroy cellular structure. Upon rehydration during thawing the cells can leak or burst.

Living biological structures and biochemical molecules can be stored for very long periods and remain functional if they are suspended in a fluid that includes one or more chemicals that prevent injury during freezing or thawing. These chemicals are referred to as a “cryoprotective agents.” Glycerol is one of the most commonly used of such chemicals. Dimethylsulfoxide (DMSO) is another.

One of the difficult compromises faced in artificial cryopreservation is limiting the damage produced by the cryoprotectant itself. DMSO and other common cryoprotectants are often toxic to cell components in the high concentrations required for cryopreservation. DMSO has known toxicity on cells, tissue, and whole organisms, including humans (See, e.g., Buchanan et al., Stem Cells and Development 2004; 13: 295-305; Syme et al., Biology Blood Marrow Transplantation 2004; 10: 135-141;

Windrum et al., Bone Marrow Transplantation 2005; 36: 601-603, the contents of which are incorporated herein by reference). Cryoprotective agents often have unexpected effects. For example, certain cells to which cryoprotectants are applied, when they are unfrozen and used may be more susceptible to becoming cancerous or succumbing to other diseases.

Another approach to cellular cryopreservation is a technique known as vitrification where the cellular material is frozen at an extremely rapid rate during which water molecules do not have the opportunity to form ice crystals. Instead, the cellular mass is transformed into a highly viscous, super cooled liquid.

The method in most common use at the present time for freezing cellular material is the combination of cryoprotectants and vitrification which comprises perfusion of cryoprotectants into cells prior to freezing. By careful balancing the cooling rate and the concentration of the cryoprotectants, those skilled in the art have been able to preserve human blood cells, spermatozoa, corneas, skin, pancreatic islets, oocytes, tissue culture cells, etc., and other whole tissues and embryos. However, damage to the cellular material, frequently extensive damage, is still experienced using these methods.

Moreover, conventional methods are not suitable for cryopreservation of more complex tissues and organs which include a multitude of cell types, each of which are thought to require a unique freeze-thaw regimen. In some instances, however, even with the use of cryoprotectants, recovery rates of cells and tissues from cryopreservation are routinely fifty-percent or less.

There have been some attempts to solve of the problems associated with cryopreservation. For example, U.S. Pat. No. 6,519,954, entitled “Cryogenic preservation of biologically active material using high temperature freezing,” that issued Prien teaches “viable biological material is cryogenically preserved (cryopreservation) by preparing the material for freezing, immersing the material in a tank of cooling fluid, and circulating the cooling fluid past the material at a substantially constant predetermined velocity and temperature to freeze the material. A method according to the present invention freezes the biologic material quickly enough to avoid the formation of ice crystals within cell structures (vitrification). The temperature of the cooling fluid is preferably between −20 degrees C. and −30 degree C., which is warm enough to minimize the formation of stress fractures in cell membranes due to thermal changes. Cells frozen using a method according to the present invention have been shown to have approximately an 80 percent survival rate, which is significantly higher than other cryopreservation methods.”

U.S. Pat. No. 5,985,538, entitled “Cryopreservation and cell culture medium comprising less than 50 mM sodium ions and greater than 100 mM choline salt,” that issued to Stachecki teaches “a cell culture medium and cryopreservation medium in which sodium chloride is replaced with an organic cation, preferably choline chloride in a concentration of at least 100 mM, resulting a residual sodium ion concentration less than about 50 mM. The cryopreservation solution is suitable for cryopreservation of unfertilized oocytes, with thawed oocytes demonstrating the ability to survive, fertilize, and for the resulting embryos to proceed to full term development.”

U.S. Pat. No. 5,424,207, entitled “Process of revitalizing cells prior to cryopreservation,” that issued to Carpenter et al. teaches “a method of revitalizing cells or tissues that are to be cryopreserved for storage at ultracold temperatures, e.g, minus 196 degrees C., is disclosed which comprises preincubation of the cells or tissue from about 5 minutes to about 24 hours. The preincubation may be conducted at a temperature ranging from about −27 degrees C. to about −42 degrees C., after which the tissue or cells are cryopreserved.”

European Patent No. EP0354474, entitled “Method and composition for cryopreservation of tissue,” that issued to Glonek et al. teaches “cryoprotectant agents and solutions are disclosed that are phoshomono and phosphodiester catabolites of phosphoglycerides. The cryoprotectants permit cold-perservation of cellular material minimizing damage caused by freezing and thawing. The cellular material cooled and/or frozen in accordance with the invention may be of animal or vegetable origin.”

U.S. Published Patent application No. 20060013805 published by Hebbel entitled “Transgenic circulating endothelial cells,” teaches “a process is provided for expanding the population of endothelial cells obtained from peripheral blood which can be transformed with a vector comprising a DNA sequence encoding a preselected bioactive polypeptide. The resulting transgenic endothelial cells are useful to biocompatibilize implantable medical devices or can be used directly, as for gene therapy.

U.S. Published Patent application No. 20050013870 published by Freyman entitled “Decellularized extracellular matrix of conditioned body tissues and uses thereof,” teaches “The present invention relates generally to decellularized extracellular matrix of conditioned body tissues. The decellularized extracellular matrix includes a biological material, preferably vascular endothelial growth factor (VEGF), produced by the conditioned body tissue that is in an amount different than the amount of the biological material that the body tissue would produce absent the conditioning. The invention also relates to methods of making and methods of using said decellularized extracellular matrix. Specifically, the invention relates to treating defective, diseased, damaged or ischemic cells, tissues or organs in a subject by administering, injecting or implanting the decellularized extracellular matrix of the invention into a subject in need thereof. The invention is further directed to a tissue regeneration scaffold for implantation into a subject inflicted with a disease or condition that requires tissue or organ repair, regeneration and/or strengthening. Additionally, the invention is directed to a medical device, preferably a stent or an artificial heart, having a surface coated or covered with the decellularized extracellular matrix of the invention or having a component comprising the decellularized extracellular matrix of the invention for implantation into a subject, preferably a human. Methods for making the tissue regeneration scaffold and methods for manufacturing a coated or covered medical device having a component comprising decellularized extracellular matrix of conditioned body tissues are also provided.

U.S. Published Patent application No. 20030077329 published by Kipp et al. entitled ” Composition of and method for preparing stable particles in a frozen aqueous matrix” teaches “the present invention discloses a composition of a stable suspension of a poorly water soluble pharmaceutical agent or cosmetic in the form of particles of the pharmaceutical agent or cosmetic suspended in a frozen aqueous matrix and method for its preparation. The composition is stable for a prolonged period of time, preferably six months or longer and is suitable for parenteral, oral, or non-oral routes such as pulmonary (inhalation), ophthalmic, or topical administration.”

U.S. Published Patent application No. 20020102239 published by Koopmans entitled “Methods for storing neural cells such that they are suitable for transplantation,” teaches The instant methods pertain to an improved methods for storing neural cells, preferably dissociated neural cells, prior to their use in transplantation and to the cells obtained using such methods. One embodiment pertains to methods for storing the neural cells in medium lacking added buffer or added protein, other embodiments feature neural cells which are maintained at 4 degrees C. prior to cryopreservation and have comparable viability and/or functionality to freshly harvested cells. In addition, methods for storing and/or transplantation of porcine neural cells are described.

U.S. Published Patent application No. 20020063235 published by Fahy entitled “Prevention of ice nucleation by polyglycerol,” teaches “linear polymers of glycerol can prevent or delay ice nucleation in a variety of contexts. Polyglycerol can also be employed in combination with other ice control agents, such as polyvinyl alcohol/polyvinyl acetate copolymers and antifreeze proteins, to provide antinucleation effects that are superior to those of either polyglycerol or the coantinucleator alone.

Polyglycerol has a number of advantageous physical and toxicological properties, such as extreme water solubility, non-toxicity to human beings, non-toxicity to animal tissues and organs in vitro even at extreme concentrations, minimal foaming tendency, minimal retention on hydrophobic surfaces, and stability in solution without the need for periodic heating to reactivate its antinucleation properties.”

However, none of these solutions solve all of the problems described above for cyropreservation agents. Thus, it would be extremely useful if non-toxic, naturally occurring endogenous molecules could be found to serve as effective cryopreservation agents.

### SUMMARY OF THE INVENTION

In accordance with preferred embodiments of the present invention, some of the problems associated with treating cryopreservation are overcome.

Cryopreservation media and molecules are presented.

The cryopreservation media utilizes naturally occurring endogenous molecules and their chemical derivatives which act as osmotically active cryopreservative agents as well as molecules which insert into and protect specific regions of cellular membranes, lead to membrane repair, maintain normal cellular levels of energy metabolites, and act as antioxidants. Cryoperserved cells can be returned to a pre- cryopreservation state without damaging the cells resulting in a very high survival rate.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a drawing illustrating the chemical structure of GPC;

FIG. 2 is a line graph illustrating the change in GPC concentration in rat brain with age;

FIG. 3 is a drawing illustrating the chemical structure of serinephosphoethanolamine;

FIG. 4 is a drawing illustrating the chemical structure of glycerophosphoinositol;

FIG. 5 is a drawing illustrating the chemical structure of myo-inositol;

FIG. 6 is a drawing illustrating the chemical structure of trehalose;

FIG. 7 is a drawing illustrating the chemical structure of taurine;

FIG. 8 is a line graph illustrating the change in taurine concentration in rat brain with age;

FIG. 9 is a drawing illustrating the chemical structure of trimethylaminetaurine;

FIG. 10 is a drawing illustrating the chemical structure of betaine;

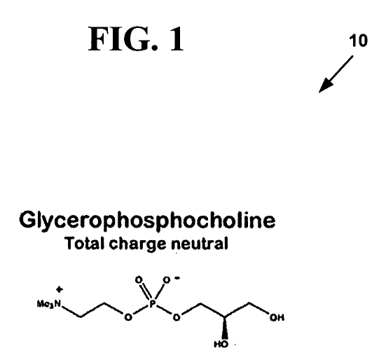

FIG. 1 is a drawing illustrating the chemical structure of glutathione;

FIG. 12 is a drawing illustrating the chemical structure of docosahexaenoate;

FIG. 13 is a drawing illustrating the chemical structure of eicosapentaenoate;

FIG. 14 is a drawing illustrating the chemical structure of acetyl-L-carnitine;

FIG. 15 is a drawing illustrating the chemical structure of eicosapentaenoyl-L-camitine;

FIG. 16 is a drawing illustrating the chemical structure of docosahexaenoyl-L-camitine;

FIG. 17 is a bar graph illustrating the decrease in fluorescamine anisotropy with the addition of trehalose to intact human erythrocytes;

FIG. 18 is a bar graph illustrating the decrease in fluorescamine anisotropy with the addition of taurine to intact human erythrocytes;

FIG. 19 is a bar graph illustrating the increase in fluorescamine anisotropy with the addition of ALCAR to intact human erythrocytes;

FIG. 20 is a bar graph illustrating the decrease in 12(9)AS anisotropy with the addition of taurine to intact human erythrocytes;

FIG. 21 is a bar graph illustrating the decrease in PPC-DPH anisotropy with the addition of myo-inositol to intact human erythrocytes; amd

FIG. 22 is a flow diagram illustrating a cryopreservation process for cryopreserving cells.

### DETAILED DESCRIPTION OF THE INVENTION

As was discussed above, cryopreservation is a technique that includes lowering a temperature of living biological structures in a sample and biochemical molecules to a point of freezing and beyond, for the purposes of storage and future recovery of its pre-frozen, viable, condition.

The term “sample” includes, but is not limited to, cellular material derived from a biological organism. Such samples include but are not limited to hair, skin samples, tissue samples, cultured cells, cultured cell media, and biological fluids. The term “tissue” refers to a mass of connected cells (e.g., central nervous system (CNS) tissue, neural tissue, eye tissue, etc.) derived from a human or other animal and plant and includes the connecting material and the liquid material in association with the cells.

The term “biological fluid” refers to liquid material derived from a human or other animal or plant. Such biological fluids include, but are not limited to, blood, plasma, serum, serum derivatives, bile, phlegm, saliva, sweat, amniotic fluid, and cerebrospinal fluid (CSF), such as lumbar or ventricular CSF. The term sample also includes media including isolated cells. The quantity of sample required to obtain a reaction may be determined by one skilled in the art by standard laboratory techniques.

The optimal quantity of sample may be determined by serial dilution.

FIG. 1 is a drawing 10 illustrating the chemical structure of GPC.

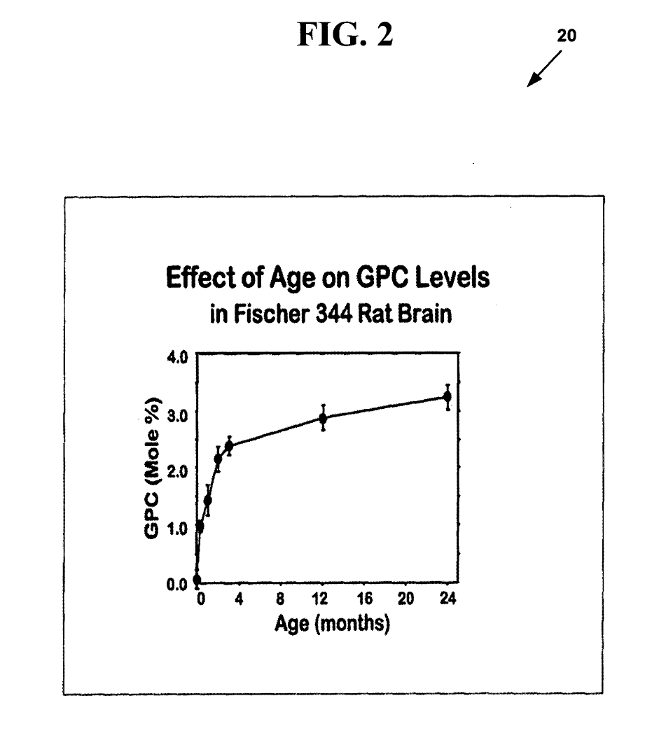

FIG. 2 is a line graph 20 illustrating the change in GPC concentration in rat brain with age.

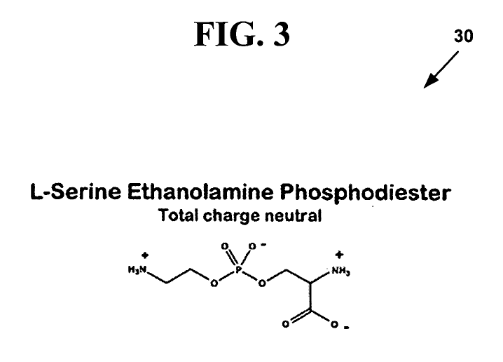

FIG. 3 is a drawing 30 illustrating the chemical structure of serinephosphoethanolamine.

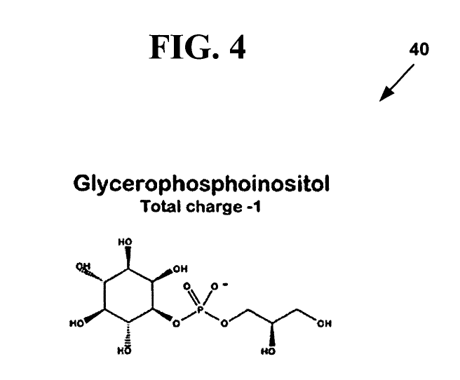

FIG. 4 is a drawing 40 illustrating the chemical structure of glycerophosphoinositol.

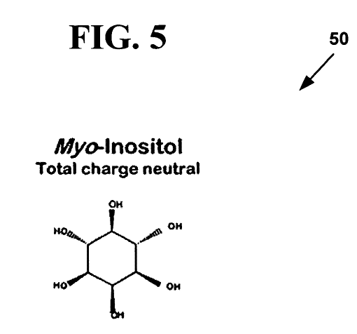

FIG. 5 is a drawing 50 illustrating the chemical structure of myo-inositol.

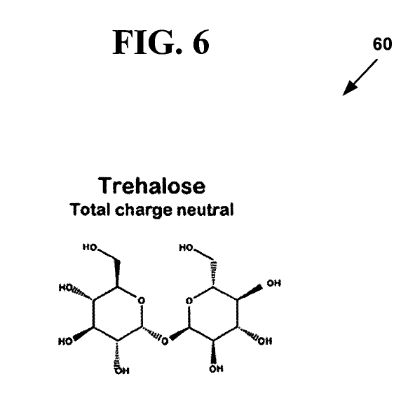

FIG. 6 is a drawing 60 illustrating the chemical structure of trehalose.

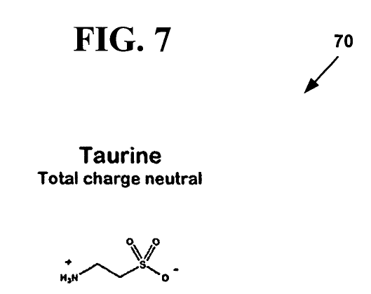

FIG. 7 is a drawing 70 illustrating the chemical structure of taurine.

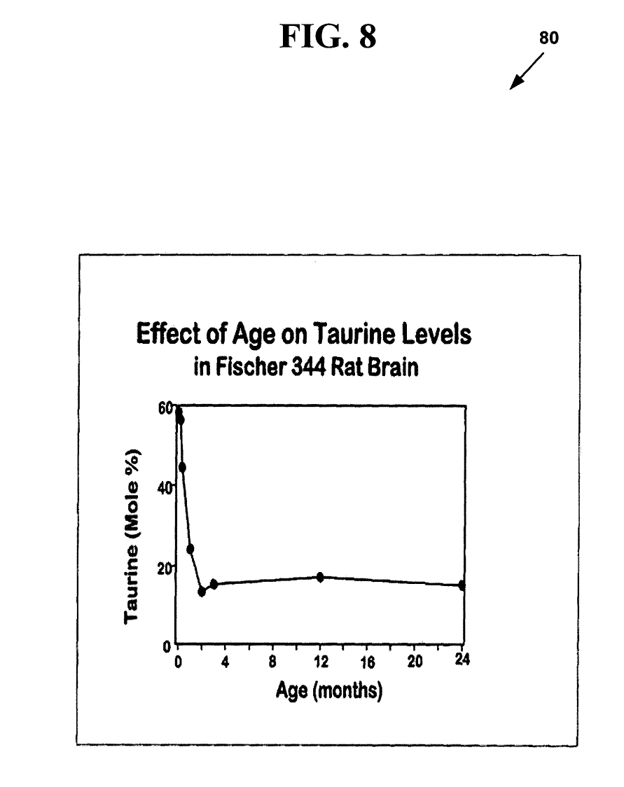

FIG. 8 is a line graph 80 illustrating the change in taurine concentration in rat brain with age.

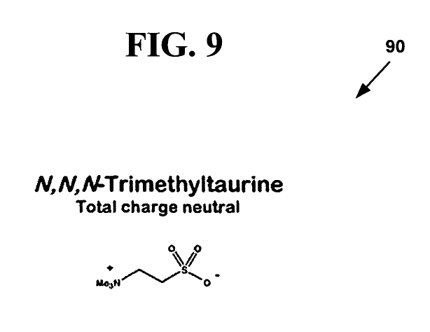

FIG. 9 is a drawing 90 illustrating the chemical structure of trimethylaminetaurine.

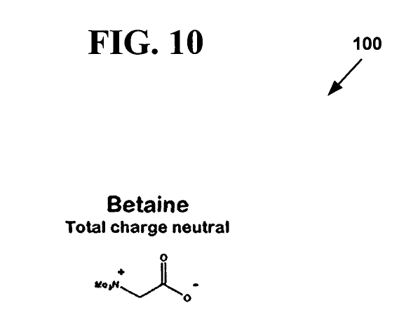

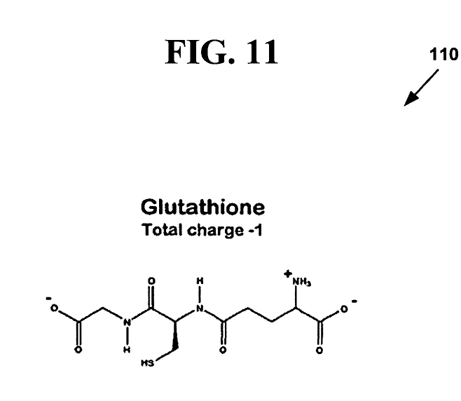

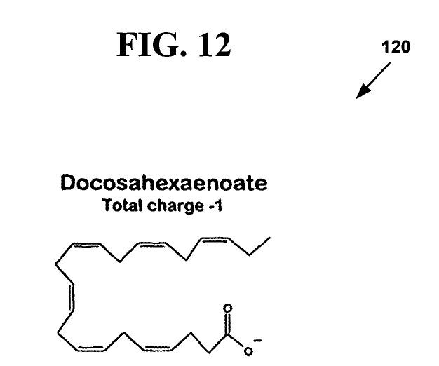

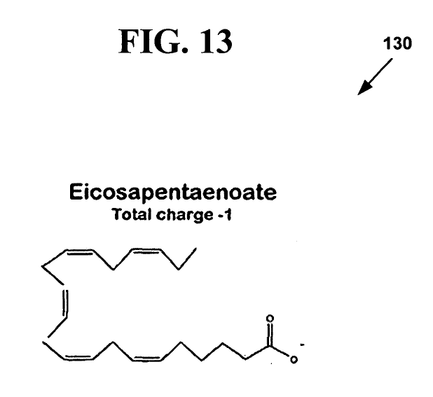

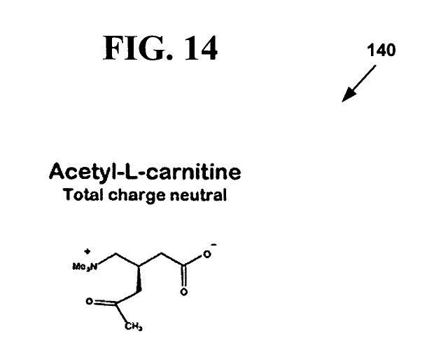

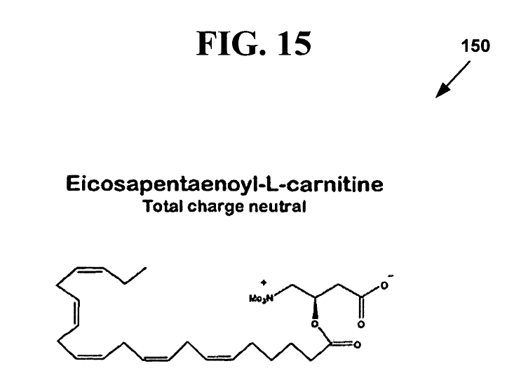

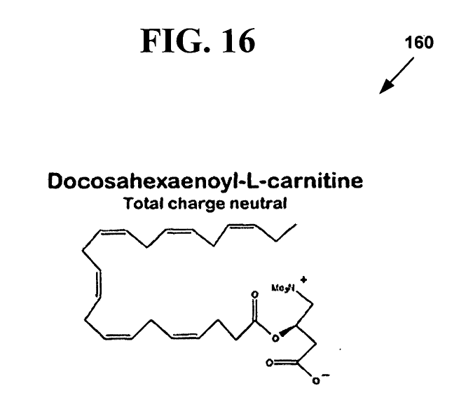

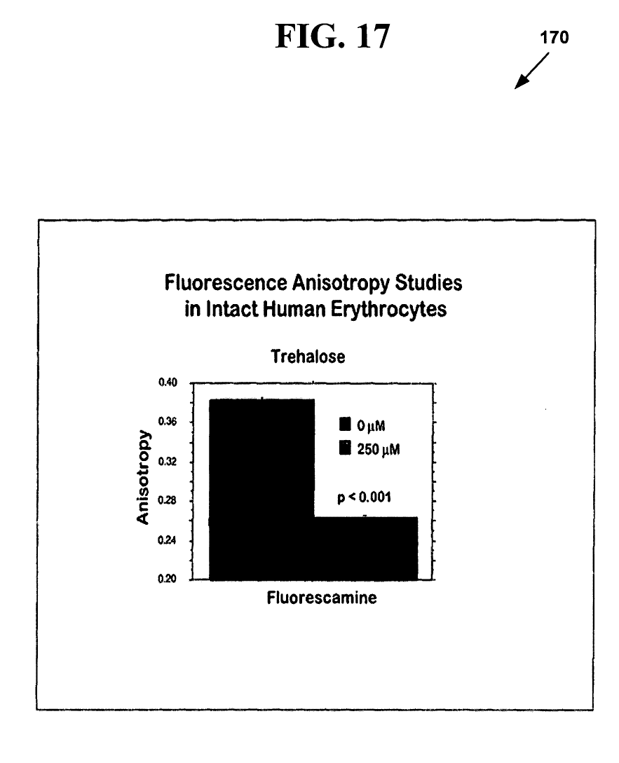

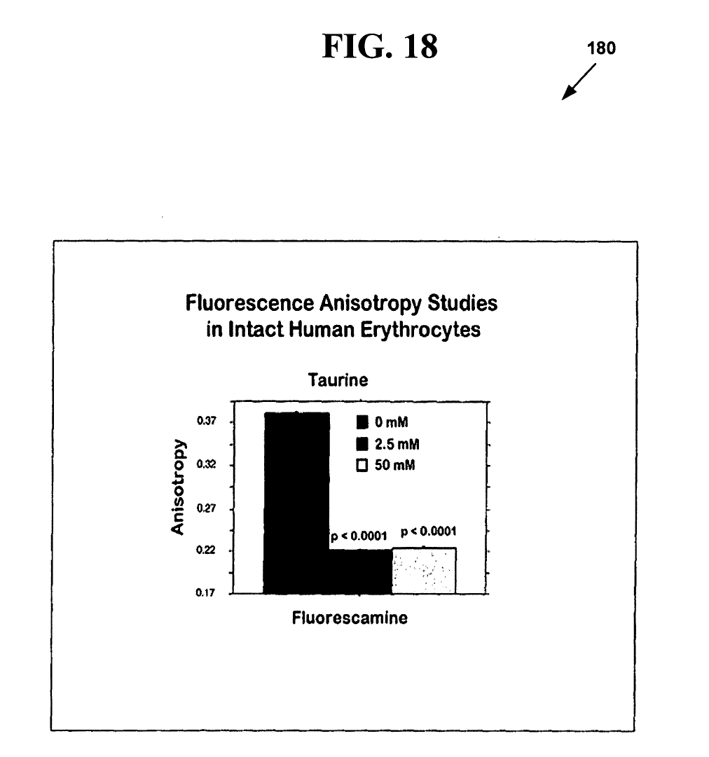

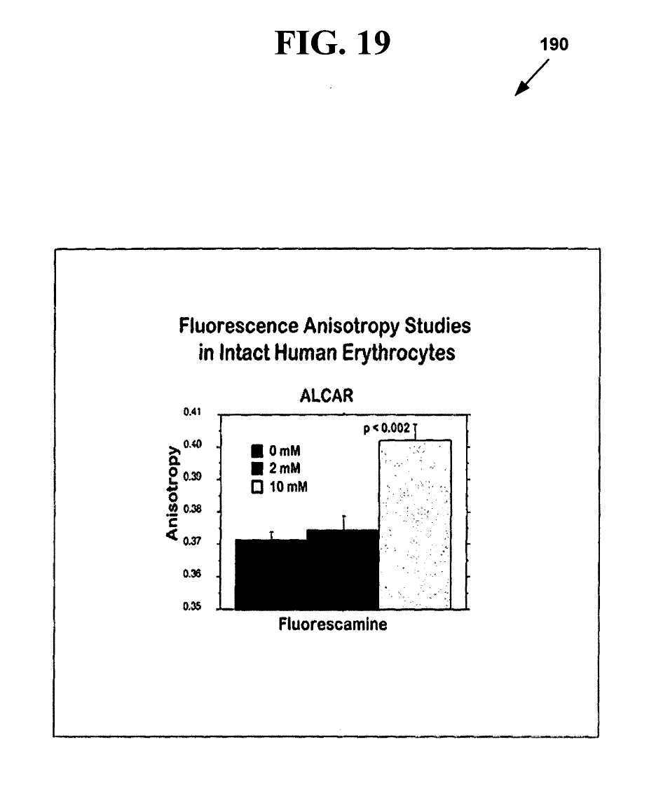

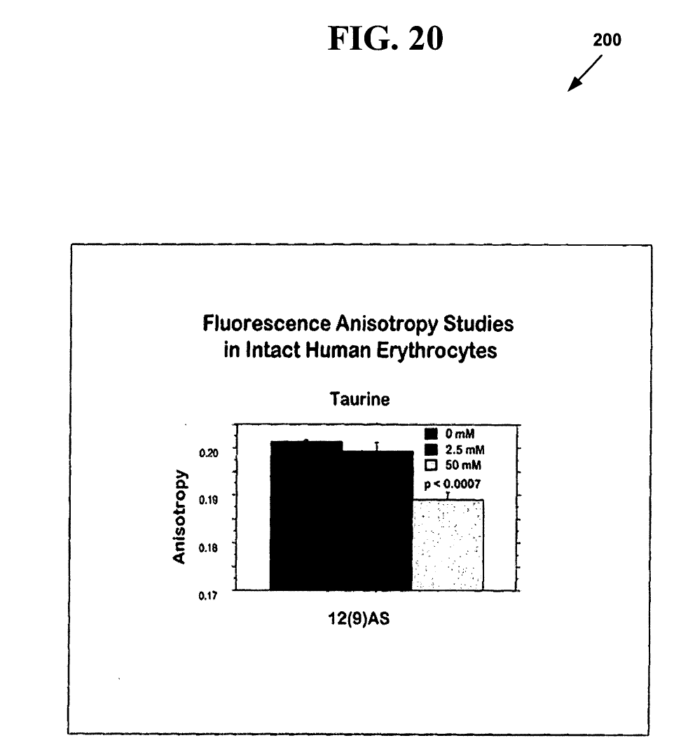

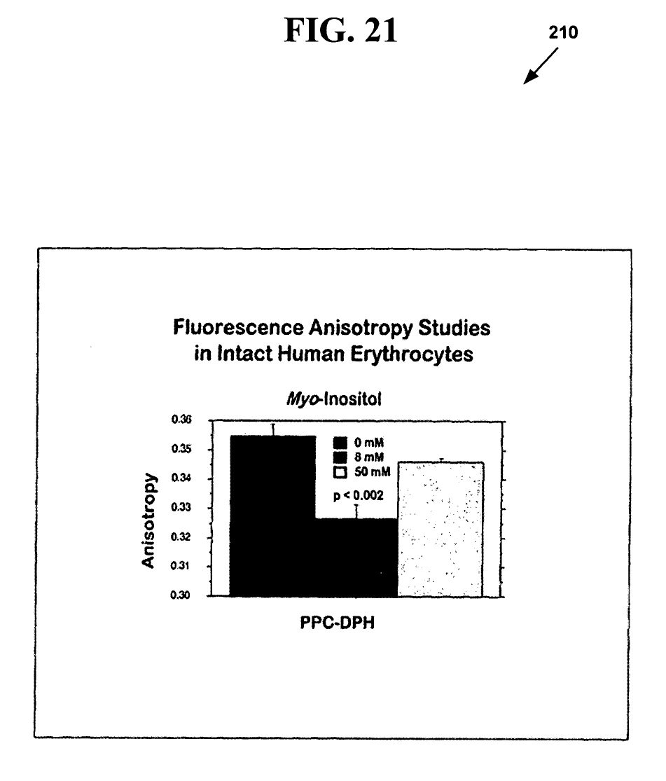

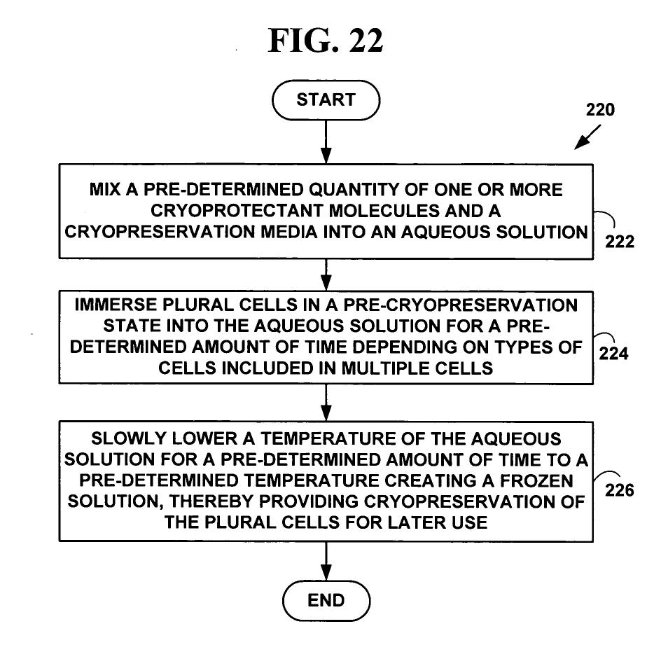

FIG. 10 is a drawing 100 illustrating the chemical structure of betaine.

FIG. 11 is a drawing 110 illustrating the chemical structure of glutathione.

FIG. 12 is a drawing 120 illustrating the chemical structure of docosahexaenoate.

FIG. 13 is a drawing 130 illustrating the chemical structure of eicosapentaenoate.

FIG. 14 is a drawing 140 illustrating the chemical structure of acetyl-L-canitine.

FIG. 15 is a drawing 150 illustrating the chemical structure of eicosapentaenoyl-L-camitine.

FIG. 16 is a drawing 160 illustrating the chemical structure of docosahexaenoyl-L-camitine.

FIG. 17 is a bar graph 170 illustrating the decrease in fluorescamine anisotropy with the addition of trehalose to intact human erythrocytes.

FIG. 18 is a bar graph 180 illustrating the decrease in fluorescamine anisotropy with the addition of taurine to intact human erythrocytes.

FIG. 19 is a bar graph 190 illustrating the increase in fluorescamine anisotropy with the addition of ALCAR to intact human erythrocytes.

FIG. 20 is a bar graph 200 illustrating the decrease in 12(9)AS anisotropy with the addition of taurine to intact human erythrocytes.

FIG. 21 is a bar graph 210 illustrating the decrease in PPC-DPH anisotropy with the addition of myo-inositol to intact human erythrocytes.

CRYOPRESERVATION MEDIA AND MOLECULES

Crvopreservation Media

A cryopreservation media, comprising an aqueous solution including varying mole fractions one or more cryoprotectant molecules, pH adjustors, buffers, osmolarity adjustors and preservatives that are not toxic to the tissue being preserved.

In one embodiment, a cryopreservation media is used without biological proteins such as those present in fetal calf serum which could include PrPSC proteins with the potential for producing transmissible spongioform encephalopathy. The cryopreservation media includes various mole fractions and concentrations of the following cryoprotectant molecules and the mole fraction composition and concentrations can be changed for optimization for different types of cells or tissues. For each osmotically active molecule, the concentration will range from two-ten times the normal observed physiological concentration. The total osmolarity of the media will be 200-500 mOsm/kg (preferably 300-400 mOsm/kg).

In one embodiment, the cryoprotectant concentrations vary from about 1 to 500 mM and more preferably between about 10 and 50 mM. This concentration is not critical, but it has been found to be a desired range for diffusion of the cryoprotectants into most cellular material.

A pH adjustor is added to the solution in an amount sufficient to provide a physiologically acceptable pH of between 6.5 to 7.5. Suitable pH adjustors include, for example, sodium hydroxide, potassium hydroxide, hydrochloric acid, phosphoric acid, sulfuric acid, etc.

Suitable buffers include, for example, inorganic phosphate, ethylenediaminetetraacetic acid, tris(hydroxymethyl)aminomethane, bicarbonate, etc.

An osmolarity adjustor is added in an amount sufficient to maintain osmolarity at between 200 to 500 mOsm/kg and preferably between 300 and 400 mOsm/kg. Suitable osmolarity adjustors include, for example, sodium chloride and glucose.

Suitable preservatives include, for example, sorbic acid, benzalkonium chloride, ethylenediaminetetraacetic acid and gentamicin.

The cryopreservation media are used with cryoprotectant molecules. This combination is used for cellular and tissue cryopreservation.

Cryoprotectant molecules

In one embodiment, the cryoprotectant molecules include naturally occurring (or derived non-naturally occurring) amphipathic phospholipid-derived phosphodiesters, including, but not limited to, glycerophosphocholine (GPC), serine ethanolamine phosphodiester, glycerophosphoinositol, diphosphotriglycerol (G-P-G-P-G), and amphipathic osmolytes including betaine, taurine, and acetyl-L-camitine; and

polyol sugars such as myo-inositol and trehalose and polyunsaturated fatty acids such as the ω-3 fatty acid docosahexaenoic acid and eicosapentaenoic acid. However, the present invention is not limited to these cryoprotectants molecules and other cryoprotectant molecules also can be used to practice the invention.

Some of the cryoprotectant molecules serve a dual purpose, that of protecting against cellular membrane damage and aiding in membrane repair when the cells are brought back to a normal temperature for cellular function (for example, acetyl-L-camitine and other acylcarnitines). The mole fraction composition and concentrations of the various molecules can be varied for optimization of cellular and tissue cryopreservation.

GPC (FIG. 1) is a phosphodiester found in mammals (See, e.g., Glonek et al. J. Neurochem. 1982; 39: 1210-1219) and plants (See, e.g., van der Rest et al. Plant Physiology 2002; 130: 244-255). GPC is a breakdown product of the membrane phospholipid, phosphatidylcholine, due to phospholipase A₁− +lysophospholipase activity and GPC can be further broken down by GPC-phosphocholine phosphodiesterase to the phosphomonoester phosphocholine+glycerol or to choline+α-glycerophosphate by GPC-choline phosphodiesterase. Therefore GPC is produced from a major membrane phospholipid and can produce the membrane phospholipid building block, phosphocholine, or choline which can be used to form the neurotransmitter acetylcholine. GPC apparently acts as a cryopreservation agent in frogs (Gastrocnemius), since GPC levels are increased approximately 3-fold in wintering frog muscle compared with levels during warm seasons (See, e.g., Glonek et al., unpublished results). In addition, GPC is a small amphipathic molecule which can easily pass through cellular membranes and act as an intracellular osmolyte. Our fluorescence spectroscopy studies of human erythrocytes incubated with GPC reveal that GPC does not alter molecular motion in any membrane region suggesting that GPC easily passes through the membrane.

³¹p MRS studies of neurodevelopment in Fischer 344 rats demonstrate that GPC levels are low at birth and rapidly rise to adult levels (FIG. 2) (See, e.g., Pettegrew et al. Journal of Neuropathology and Experimental Neurology 1990; 49: 237-249). Brain levels of GPC are elevated in normal brain aging and further elevated in Alzheimer's disease. GPC also can interact with Aβ(1-40) peptide which is elevated in AD brain. Aβ(1-40) can slowly catalyze the conversion of GPC to either PC+glycerol or choline+α-glycerophosphate, depending on the membrane and solvent environment (See, e.g., Pettegrew et. al. Abstract Viewer/Itinerary Planner 2005; Washington, D.C.: Society for Neuroscience: Program No. 704.9). Cryopreservation media will include GPC in concentrations and mole fractions optimized for the particular cells or tissues.

L-Serine ethanolamine phosphodiester (FIG. 3) is found in animals and represents 19% of the total phosphate in winter toad gastrocnemius, 6.4% of the total phosphate in turtle muscle and 2.1% (1.9 μmol/g of tissue) of the total phosphate in dystrophic chicken pectoralis muscle (See, e.g., Chalovich et al. Archives of Biochemistry and Biophysics 1977; 182: 683-689). Cryopreservation media will include L-serine ethanolamine phosphodiester in concentrations and mole fractions optimized for the particular cells or tissues.

Glycerophosphoinositol (FIG. 4) is a phospholipid metabolite found in all eukaryotes. It is derived from phosphatidylinositol by enzymatic cleavage with phospholipase A₂ (PLA₂) to give arachidonic acid and lyso-phosphatidylinositol which is converted in the cytosol to glycerophosphoinositol by lysophospholipase A (lysoPLA) (See, e.g., Corda et al. Biochimica et Biophysica Acta 2002; 1582: 52-69). Glycerophosphoinositol is a hydrophilic compound that permeates cell membranes. Cryopreservation media will include glycerophosphoinositol in concentrations and mole fractions optimized for the particular cells or tissues.

Myo-inositol (FIG. 5) is a cyclohexanehexol found in cyanobacteria, algae, fungi, plants and is produced by biosynthesis starting with D-glucose 6-P. Myo-inositol occupies a central role in plant metabolism. Myo-inositol is an osmolyte that accumulates (along with sugars and other polyols) in organisms that tolerate or avoid freezing (See, e.g., Yancey Journal of Experimental Biology 2005; 208: 2819-2830). For example, in overwintering ladybird beetles myo-inositol may act as a cryoprotectant, increasing more that 4-fold during winter months, from 2.5 to 11 μg/mg wet weight (See, e.g., Kostal et al. Cryo Letters 1996; 17: 267-272). Cryopreservation media will include myo-inositol in concentrations and mole fractions optimized for the particular cells or tissues.

Trehalose (1α-D-glucopyranosyl-1,1-α-D-glycopyranoside, See FIG. 6) is a non-reducing disaccharide that is found widely in bacteria, fungi, and plants (See, e.g., Thevelein Microbiological Reviews 1984; 48: 42-59) and is especially common in anhydrobiotic organisms which are capable of surviving extended periods of dehydration (See, e.g., Crowe, Crowe, and Chapman, Science 1984; 223:701-703). High levels of trehalose in yeast are correlated with resistance to dehydration (See, e.g., Gadd et al., FEMS Microbiology Letters 1987; 48:249-254) and freezing (See, e.g., Hino et al.,

Applied and Environmental Microbiology 1990; 56: 1386-1391). Possible mechanisms for these actions of trehalose in yeast include lowering the temperature of the membrane gel to liquid crystal phase transition (See, e.g., Leslie et al., Biochimica et Biophysica Acta 1994; 1192: 7-13), and replacing and restructuring water (See, e.g., Sano et al., Cryobiology 1999; 39: 80-87).

Since the intracellular levels of trehalose are regulated in fungi, bacteria, and plants in response to dehydration and freezing, trehalose can act as an important intracellular cryopreservative. However, trehalose is not normally found in the intracellular space of animal cells and no mammalian transport system has been described to transport trehalose into mammalian cells. Trehalose has been described as having mammalian cell cryopreservation properties in concentrations of 0.25 M to 1.0 M but these were under conditions in which the cellular membrane was altered genetically (See, e.g., Buchanan et al., Stem Cells and Development 2004; 13: 295-305) or by induced thermotropic lipid-phase transition allowing trehalose to enter the cells (See, e.g., Beattie et al., Diabetes 1997; 46: 519-523). There is one report of trehalose cryopreservation potential in hematopoietic stem cells without apparent membrane alteration (See, e.g., Scheinkonig et al., Bone Marrow Transplantation 2004; 34: 531-536). For mammalian cells, trehalose under usual cryopreservation techniques will be primarily an extracellular osmotically active molecule. Cryopreservation media will include trehalose in concentrations and mole fractions optimized for the particular cells or tissues.

Taurine (2-aminoethanesulfonic acid) (FIG. 7), a nonproteinaceous amino acid, is an important organic osmolyte in mammalian cells but not plant cells. Taurine is the most abundant free amino acid in the heart, retina, and skeletal muscles, with concentrations reaching 50 mM in leukocytes (See, e.g., Schuller-Levis and Park Neurochemical Research 2004; 29: 117-126; and Fukada et al. Clin. Chem. 1982; 28: 1758-1761).

In the CNS, taurine is synthesized from cysteine by the cysteine sulfinate decarboxylase (CSD; EC 4.1.1.29) and accounts for as much as 50% of the additional osmolytes needed for brain volume regulation (See, e.g., Beetsch and Olson Am. J.

Physiol. 1998; 274: C866-C874). Taurine levels are high in developing human brain (3.4 mmole/kg) (See, e.g., Kreis et al. Magnetic Resonance in Medicine 2002; 48: 949-958).

Rat brain studies demonstrate neurodevelopmental regulation of taurine levels which are high at birth (See, e.g., Miller et al. Comparative Biochemistry and Physiology Part A 2000; 125: 45-56) and decrease three-fold from newborn to 2-month old rats (Pettegrew and Panchalingam, unpublished data) (FIG. 8).

In addition to its role in keeping cellular osmotic pressure of cells equal to that of the external fluid environment, taurine has been shown to be tissue protective in models of oxidant-induced injury (See, e.g., Takahashi et al. J. Cardiovasc. Pharmacol. 2003; 41: 726-733) probably by enhancing other cellular antioxidant functions (See, e.g., Yancey Journal of Experimental Biology 2005; 208: 2819-2830). Taurine supplementation may be beneficial in protecting transplanted organs from ischemic injury (See, e.g., Wettstein and Haussinger Transplantation 2000; 69: 2290-2296). Taurine also has been reported to be beneficial in the cryopreservation of human fetal liver cells (See, e.g., Limaye and Kale, Journal of Hematotherapy and Stem Cell Research 2001; 10: 709-718) and the cryopreservation of frozen bull sperm (See, e.g., Chen et al. Cryobiology 1993; 30: 423-431). Cryopreservation media will include taurine in concentrations and mole fractions optimized for the particular cells or tissues.

N,N,N-Trimethyltaurine (FIG. 9) is a derivative of taurine found in marine animals, for example, the marine sponge Agelas dispar (See, e.g., Cafieri et al. J. Natural Products 1998; 61: 1171-1173); Mediterranean brown seaweeds (See, e.g., Amico et al.

Biochemical Systematics and Ecology 1978; 4: 143-146); and red algae (1.3-3.4 mmol/kg dry weight) (See, e.g., Impellizzeri et al. Phytochemistry 1975; 14: 1549-1537).

Cryopreservation media will include N,N,N-trimethyltaurine in concentrations and mole fractions optimized for the particular cells or tissues.

Betaine (N,N,N-trimethylglycine) (FIG. 10) is a methylamine organic osmoprotectant found in both eukaryotic and prokaryotic cells. Bacteria accumulate high concentrations of organic osmolytes, such as betaine, to counteract efflux of water from cells without disrupting vital cellular function. This may be due to the exclusion of the compatible solutes from the immediate hydration shell of proteins perhaps due to the unfavorable interactions with protein surfaces (See, e.g., Schiefner, et al. J. Biol. Chem. 2004; 279: 5588-5596). Betaine also is effectively excluded from the anionic surface and first two layers of water of duplex DNA since the biopolymer prefers to interact with water rather than betaine (See, e.g., Felitsky et al. Biochemistry 2004; 43: 4732-14743).

Betaine plays an important role in conferring tolerance to low temperature in bacteria and higher plants. A three-fold accumulation of betaine was found during a cold acclimation period in experiments to develop freezing tolerance of wheat (winter wheat Fredrick). Also, exogenous betaine application resulted in a large increase in total osmolarity (See, e.g., Allard et al. Plant and Cell Physiology 1998; 39: 1194-1202). Betaine can effectively protect seeds against low-temperature stress during imbibition and germination. Arabidopsis thaliana plants were transformed with the coda gene to allow the plants to synthesize betaine in vivo and a correlation was reported between the level of accumulated betaine and the tolerance to low temperature of the genetically transformed plants (See, e.g., Alia et al. Plant, Cell and Environment 1998; 21: 232-239). Also, genetic transformation of tomato (Lycopersicon esculentum Mill.) plants to include a biosynthetic pathway for betaine is reported to be an effective strategy for improving chilling tolerance (See, e.g., Park et al. The Plant Journal 2004; 40: 474-487). Betaine provides enhanced cryotolerance on gram-positive bacteria, Listeria monocytogenes, allowing it to grow under refrigerated conditions (See, e.g., Ko et al. Journal of Bacteriology 1994; 176: 426-431).

Betaine occurs in common foods, both plants (toasted wheat germ, 1240 mg/100 g and raw spinach, 600 mg/100 g) and animals (canned shrimp, 219 mg/100 g) (See, e.g., Zeisel et al. J. Nutrition 2003; 133: 1302-1307). Betaine exists in human plasma at concentrations of about 30 μmol/L with a range of 9 to 90 μmol/L (See, e.g., Ueland, Holm, Hustad Clinical Chemistry and Laboratory Medicine 2005; 43: 1060-1075) although humans obtain betaine from foods that include betaine or choline-includeing compounds (See, e.g., Craig Am. J. Clin. Nutr. 2004; 80:539-549). Cryopreservation media will include betaine in concentrations and mole fractions optimized for the particular cells or tissues.

Glutathione, γ-glutamylcysteinylglycine (FIG. 11), is present in high concentrations in most living cells and is a major cellular antioxidant that can protect cells and tissue from oxidative stress mediated free radical damage of membrane polyunsaturated lipids, cellular proteins, and DNA. Glutathione is. synthesized from glutamate, cysteine and glycine by two ATP-dependent reactions catalyzed by γ-glutamylcysteine synthetase and glutathione synthetase. Under conditions of oxidative stress leading to reduced ATP levels, glutathione synthetases could be compromised.

Glutathione concentration i human brain is 1-5 mM (See, e.g., Terpstra et al. Magnetic Resonance in Medicine 2003; 50: 19-23) and in rat plasma glutathione concentration is 78.4 μM (See, e.g., Mamprin et al. Cryobiology 2000; 40: 270-276).

Membrane integrity requires adequate levels of the reduced form of glutathione (GSH) to remove H₂O₂ which may accumulate in plants during chilling and cold acclimation (See, e.g., Kocsy et al. Physiologia Plantarum 2001; 113: 158-164) and the addition of glutathione to the cryoprotectant media may help preserve membrane integrity. Membrane fatty acid damage by free radicals can be especially important in cell membranes with high levels of polyunsaturated fatty acids such as spermatozoa (See, e.g., Baumber et al. J. Androl. 2003; 24: 621-628 and Chatterjee et al. Molecular Reproduction and Development 2001; 60: 498-506). Cryopreservation media will include glutathione in concentrations and mole fractions optimized for the particular cells or tissues.

The highly unsaturated ω3 fatty acids DHA (docosahexaenoic acid, 22:6) (FIG. 12) and EPA (eicosapentaenoic acid, 20:5) (FIG. 13) are widespread in nature, especially in marine organisms and human neurons. EPA and DHA are found in human plasma at 0.03±0.01 mole % and 1.86±0.51 mole % (levels of non-esterified fatty acids), respectively (See, e.g., Conquer and Holub, Journal of Lipid Research 1998; 39: 286-292, the contents of which are incorporated herein by reference). Esterified DHA human brain concentration was found to be 10 μmol/g and almost no EPA is found in human brain (See, e.g., Kemin et al. Current Opinion in Clinical Nutrition and Metabolic Care 2002; 5: 133-138, the contents of which are incorporated herein by reference). DHA is more compact than fatty acids with more saturated chains; DHA chains have an average length of 8.2 Åat 41° C. compared to 14.2Å for oleic acid (18:1). The compact shape of DHA and EPA are expected to contribute hyperfluidity to membrane bilayers which enable marine organisms to carry out respiration at temperatures near 0° C. and under tremendous hydrostatic pressure. The hyperfluidity of mitochondrial and chloroplast membranes increases electron transfer between all redox partners in a diffusion-coupled model (See, e.g., Gupte et al. Proc. Natl. Acad. Sci. USA 1984; 81: 2606-2610). Similarly, high membrane fluidity would maximize collisions between the proteins rhodopsin and transducin in rhodopsin disks which is essential for low light detection. In humans, EPA is found primarily in cholesterol esters, triglycerides, and phospholipids. DHA is found primarily in phospholipids and is highly concentrated in the cerebral cortex, retina, testes, and sperm. DHA is the predominant ω-3 fatty acid in brain. Both DHA and EPA can be linked to phospholipase A₂ activity, inflammation, neurotransmission, membrane fluidity, oxidation, ion channel and enzyme regulation, and gene expression. Epidemiological evidence suggests that low blood levels of ω-3 fatty acids are associated with several neuropsychiatric disorders including Alzheimer's disease, attention deficit disorder, depression, and schizophrenia (See, e.g., Young and Conquer Reprod. Nutr. Dev. 2005; 45: 1-28). Cryopreservation media will include DHA and EPA in concentrations and mole fractions optimized for the particular cells or tissues.

Acetyl-L-carnitine (ALCAR) (FIG. 14) includes carnitine and acetyl moieties, both of which have neurobiological properties. Carnitine is important in the β-oxidation of fatty acids and the acetyl moiety can be used to maintain acetyl-CoA levels.

Other reported neurobiological effects of ALCAR include modulation of: 1) brain energy and phospholipid metabolism; 2) cellular macromolecule, including neurotrophic factors and neurohormones; 3) synaptic morphology; and 4) synaptic transmission of multiple neurotransmitters. Potential molecular mechanisms of ALCAR activity include: 1) acetylation of —NH₂ and —OH functional groups in amino acids and N terminal amino acids in peptides and proteins resulting in modification of their structure, dynamics, function and turnover; and 2) acting as molecular chaperone to larger molecules resulting in a change in the structure, molecular dynamics, and function of the larger molecule. ALCAR is reported in double-blind controlled studies to have beneficial effects in major depressive disorders and Alzheimer's disease, both of which are highly prevalent in the geriatric population (See, e.g., Pettegrew et al. Molecular Psychiatry 2000; 5: 66616-632).

In mammalian systems, carnitine is required for transport of fatty acids across the inner mitochondrial membrane for energy production via 3-oxidation, and the acetyl moiety can be used to maintain acetyl-CoA levels (See, e.g., lacobazzi et al.

Biochem. Biophys. Res. Commun. 1998; 252: 770-774). Although details are less well established in plants (See, e.g., Graham and Eastmond Prog. Lipid Res. 2002; 41: 156-181), the accumulating biochemical, enzymatic and molecular evidence has provided evidence for the same role for carnitine in plants (See, e.g., Masterson and Wood Physiologia Plantarium 2000; 109: 217-224) especially under conditions which reduce glyoxylate pathway activity and stimulate β-oxidation of fatty acids (See, e.g., Sharma et al. IUPAC sponsored Second International Symposium on Green/Sustainable Chemistry, Dehli, India 2006; IL-31). Carnitine is present in mammalian cells and tissues in relatively high concentrations as either free camitine (beef steak 592 ±260 :mol/100 g) or as acylcamitines including ALCAR at concentrations approximately 10% of carnitine concentrations (See, e.g., Broquist, Modem Nutrition 1994; Lea & Febiger, Baltimore: 459-465). Carnitine and ALCAR concentrations are much lower in plants (carnitine in: wheat seed 2.5 :mol/100 g; wheat germ 7.4 mol/100g; oat seedling 8.6 :mol/100g; and avocado mesocarp 29.6 :mol/100 g) (See, e.g., Panter and Mudd FEBS Lett 1969; 5: 169-170). Other acylcamitines to be used in the cryopreservation media include but are not limited to esters of the ω-3 polyunsaturated fatty acids eicosapentaenoic acid (FIG. 15) and docosahexaenoic acid (FIG. 16). Cryopreservation media will include acylcamitines in concentrations and mole fractions optimized for the particular cells or tissues.

Membrane Insertion Sites For Cryopreservation Molecules

Since the cellular membrane has repeatedly been shown to be the primary site of freeze-related damage, it is important to use a cryopreservation media includeing cryoprotectant molecules which can insert into specific regions of the membrane and thereby displace water molecules in those areas; it is the freezing of these water molecules resulting in ice crystal formation which causes the major membrane damage.

The cellular membrane is usually divided into the following three regions:

(1) membrane surface includeing proteins and glycolipids extending into the extracellular or intracellular hydrophilic (water rich) spaces; (2) phospholipid head group region which has both hydrophilic (water) and hydrophobic (lipid) characteristics and; (3) the hydrophobic hydrocarbon core which includes the phospholipid fatty acids which under normal physiological temperatures are in a liquid crystalline state. Increasing the mole fraction of polyunsaturated fatty acids decreases the gel-to-liquid crystal transition temperature.

Fluorescence spectroscopy anisotropy measurements are highly sensitive to the dynamic molecular motion surrounding a fluorophore. By using specific fluorophores which insert into specific regions of the cellular membrane, molecular motion can be monitored in these areas. Dr. Pettegrew has over the past 25-30 years developed highly sensitive and specific methods of monitoring molecular motion in specific regions of the cellular membrane in living cells such as human erythrocytes, lymphocytes, and fibroblasts. These methods have now been applied to human erythrocytes in order to determine which cryopreservation molecules can insert into specific regions of these living cellular membranes and thereby displace water molecules in these membrane regions protecting them from freeze-related damage. Molecular motion of erythrocyte membrane surface proteins, glycoproteins and the phospholipids phosphatidylethanolamine and phosphatidylserine was monitored by the fluorophore fluorescamine. Molecular motion of the erythrocyte membrane phospholipid head group region was monitored by N-(5-dimethylaminonaphthaline-1-sulfonyl_-1,2-dihexadecanoyl-sn-glycero-3-phosphoethanolamine (DPPE-ANS) and molecular motion of the membrane hydrocarbon region was monitored by 12-(9-anthroyloxy) stearic acid [12(9)AS] and 2-(3-(diphenylhexatrienyl)propanoyl)-1-hexadecanoyl-sn-glycero-3-phosphocholine (PPC-DPH) (See, e.g., Pettegrew et al., Depression 1993; 1: 88-100).

Based on experimental fluorescence spectroscopic anisotropic studies, it was determined that the following cryoprotectants insert into specific regions of the human erythrocyte membrane which serves as a model cell system for the exemplary studies included herein. Trehalose (e.g., 250 μ M) specifically interacts with the erythrocyte membrane surface (p<0.0001) (FIG. 17) as does taurine (2.5 mM, p<0.0001; mM, p<0.0001) (FIG. 18) and acetyl-L-carnitine (10 mM, p<0.002) (FIG. 19). Molecules which insert into the hydrocarbon core of erythrocyte membranes are taurine (50 mM, p=0.0007) (FIG. 20) and myo-inositol (8 mM, p=0.002) (FIG. 21). These effects are observed immediately after addition of the cryoprotectant molecules and continue unchanged for at least 24 hours. Trehalose and taurine greatly increase molecular motion on the erythrocyte membrane surface, but acetyl-L-carnitine greatly decreases motion in the same area. Both taurine and myo-inositol increase molecular motion in the hydrocarbon core of the erythrocyte membrane. GPC and betaine do not alter molecular motion in any erythrocyte membrane region suggesting that GPC and betaine easily pass through the membrane without perturbing molecular motion in any membrane region. Inside the cell GPC and betaine are expected to reorder the structure of bulk water but be excluded from the immediate hydration shells of proteins, DNA, and RNA which would stabilize the conformation of these molecules.

Cryopreservation Process

FIG. 22 is a flow diagram 220 illustrating a cryopreservation process for cryopreserving cells. At Step 222, a pre-determined quantity of one or more cryoprotectant molecules and a cryopreservation media are mixed into an aqueous solution. At Step 224, a plural cells in a pre-cryopreservation state are immersed into the aqueous solution for a predetermined amount of time depending on types of cells included in the plurality of cells. At Step 224, the temperature of the aqueous solution is slowly lowered for a pre-determined amount of time to a pre-determined temperature creating a frozen solution, thereby providing cryopreservation of the plurality of cells for later use.

In one embodiment, an appropriate quantity of one or more cryoprotectants are mixed into an aqueous solution so that the final concentration in the cryopreservative media is within the concentration ranges discussed above. In one embodiment, the cryoprotectants are in concentrated form. In another embodiment, the cryoprotectants are not in concentrated form. The mole fraction and cryoprotectant concentration can be optimized for specific cells and tissues.

The time of immersion of the cellular mass in the cryopreservation media is dependent upon the properties of the cellular mass to be preserved. For example, cryoprotectants rapidly diffuse into low density materials such as cellular suspensions or comeas with immersion times from one minute to one hour duration being suitable for such materials. Longer times up to three hours or more might be required for materials of greater density. For materials of higher density, such as organs-i.e., hearts, kidneys, livers, etc., it may be more desirable to diffuse the cryoprotectant into the cellular mass by injection or by pumping (perfusing) the cryopreservative through blood vessels passing through the organ. The cryoprotectants of the invention are also suitable for the cryopreservation of liquids such as body fluids (semen, blood).

Following diffusion of the cryoprotectants into the cellular mass, the cellular mass is prepared for cryopreservation. To accomplish cryopreservation, the temperature of the cellular mass is reduced to preferably below zero ° C. and more preferably, to a temperature ranging between zero ° C. and −196° C. The cellular mass including the diffused cryoprotectants is cooled within a period of time ranging from about five minutes up to twenty four hours. Preferably, the cellular mass is cooled gradually over a period of time of from one to four hours. Placing a cellular mass at room temperature into a cooling chamber preset to a desired cryopreservation storage temperature is a satisfactory means for slow cooling of the cellular mass to the desired storage temperature.

### Example of the Effectiveness of Glycerophosphocholine (GPC)

Experimental data is presented which documents and demonstrates the effectiveness of one of the cryoprotectant molecules, namely, glycerophosphocholine (GPC), on the preservation of corneas. The following example illustrates the experimental data. However, the use of GPC is exemplary only, and the invention is not limited to GPC cyroprotectant molecules and other cyroprotectant molecules can be used to practice the invention.

Corneas were removed from their host animal (e.g., a cat) using the following procedure. A lethal intramuscular dose of sodium pentobarbital was administered to a cat and its eyes were promptly enucleated. The eye globes were secured in sterile gauze and examined in order to confirm that the corneas were clear with intact epithelium, minimal Descemet's folds, and absent guttata.

During enucleation, special care was taken to avoid damaging or touching the epithelium. A scleral groove incision Imm from the limbus of each eye was extended circumferentially with a Bard Parker #15 scalpel blade. Over a 3 mm region of this incision a depth was made so the underlying uveal tissue appeared as a knuckle. At this point, a curved corneal scissors was used to enter the eye though avoiding damage to the uveal tissue such that the anterior chamber was maintained, and the cornea was excised.

During excision, care was taken to prevent excessive corneal bending and iris from touching the corneal endothelium. Corneas with attached scleral ring were then placed in medium in a standard eye bank viewing chamber on a platform with endothelial side up. Two 1-year old cat corneas excised in the above manner were placed in a McKary-Kaufinan tissue culture storage medium (standard eye bank storage medium having a pH of 7.4 and an osmolarity of 320±/−5 mOsm/kg-hereafter M-K medium) included in an NMR sample tube.

A volume of GPC was added to the M-K medium in an amount sufficient to provide an M-K solution 30 mM in GPC. The GPC was added to allow pH determination of an ex vivo cornea during an incubation period. Corneas were stored in the medium at room temperature for a period of 1 hour, after which the corneas were rinsed several times in a standard M-K medium free of GPC. P-31 NMR analysis was run on the corneas, and both the GPC and Pi signals were recorded.

The degree of shift in the Pi (pH sensitive) magnetic resonance signal with respect to the GPC (pH insensitive) magnetic resonance signal allowed pH determination according to known and established methods (See, e.g., Barany and Glonek, Phosphorus-31 NMR, Principles and Applications 1984; Gorenstein editor; Academic Press New York, 511-515; Pettegrew et al., Magn. Reson. Imaging 1988; 6: 135-142), and was found to be stable at pH 7.2. The GPC signal intensity emanating from the cornea increased to 30 to 40% of the total detectable phosphorus as a consequence of the incubation period. The experiment was repeated 10 times. After corneas were removed from the test medium, P-31 NMR was performed on the medium alone and it was discovered that little to no GPC was present in the medium; as most of the 30 mM GPC originally added to the medium had become concentrated in the cornea. This again demonstrates the GPC can easily pass through cellular membranes.

The cornea remained transparent and the GPC signal in the cornea was greatly increased. The amount of GPC taken up by the cornea and the amount of GPC remaining in the cryopreservation solution depends on the incubation time, size of the cornea, and the amount of preservation medium.

The solutions of the subject invention are suitable for the cryopreservation of both animal and vegetable cellular material with at least an estimated survival rate of 95%. It is particularly useful for the cryopreservation of cells; comeas; tissues of the cardiovascular system such as heart, blood, and blood vessels; tissues of the respiratory system such as lung tissue; tissues of the digestive system such as liver and pancreas tissues; tissues of the urinary tract such as kidney tissues; neural tissues; tissues of the musculoskeletal system such as tendon; and embryonic tissue. Examples of vegetable-type materials that would be preserved include, for example, bulbs, tubers, rhizomes, embryos of plants.

The proposed cryopreservation media uniquely includes non-toxic, naturally occurring molecules, several of which have been shown to function as antifreeze molecules in animals (See, e.g., Glonek et al. 2002; unpublished results; Kostal et al. Cryo Letters 1996; 17: 267-272) and plants (See, e.g., Hino et al., Applied and Environmental Microbiology 1990; 56: 1386-1391; Allard et al. Plant and Cell Physiology 1998; 39: 1194-1202; Alia et al., Plant, Cell and Environment 1998; 21: 232-239). Other molecules function as antioxidants, modulators of cellular energy and membrane metabolism and trophic factors. The mole fractions and concentrations of these molecules can be optimized for cryopreservation of specific animal (including human) or plant cells and tissues. In addition, the cryopreservation media uniquely includes molecules which target and therefore protect specific regions of the cell surface and intracellular membranes as well as the extracellular and intracellular spaces of cells and tissues obtained from animals (including humans) and plants. The proposed cryopreservation media produce survival rates of up to 90% or greater for cells and tissues.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

It should be understood that the architecture, programs, processes, methods and systems described herein are not related or limited to any particular type of component or compound unless indicated otherwise. Various types of general purpose or specialized components and compounds may be used with or perform operations in accordance with the teachings described herein.

In view of the wide variety of embodiments to which the principles of the resent invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. A cryopreservation media, comprising:
an aqueous solution including varying mole fractions of one or more cryoprotectant molecules, pH adjustors, buffers, osmolarity adjustors and preservatives that are not toxic to a biological sample being preserved.

2. The cryopreservation media of claim 1 wherein the varying mole fractions of the one or more cryoprotectant molecules include cryoprotectant concentrations that vary from about 1 to 500 mM and more preferably between about 10 and 50 mM.

3. The cryopreservation media of claim 1 wherein the pH adjustors include sodium hydroxide, potassium hydroxide, hydrochloric acid, phosphoric acid, or sulfiric acid to adjust a pH of the aqueous cryopreservation media to a pH between 6.5 to 7.5.

4. The cryopreservation media of claim 1 wherein the buffers include inorganic phosphate, ethylenediaminetetraacetic acid, tris(hydroxymethyl)aminomethane or bicarbonate.

5. The cryopreservation media of claim 1 wherein the osmolarity adjustors include sodium chloride and glucose to adjust an osmolarity between 300 and 400 mOsm/kg.

6. The cryopreservation media of claim 1 wherein the preservatives include sorbic acid, benzalkonium chloride, ethylenediaminetetraacetic acid or gentamicin.

7. The cryopreservation media of claim 7 wherein the one or more cryoprotectant molecules comprise:
naturally occurring or derived non-naturally occurring amphipathic phospholipid-derived phosphodiesters, including glycerophosphocholine (GPC), serine ethanolamine phosphodiester, glycerophosphoinositol or diphosphotriglycerol (G-P-G-P-G);
amphipathic osmolytes including betaine, taurine, and acetyl-L-carnitine;
polyol sugars including myo-inositol and trehalose; and
polyunsaturated fatty acids including 3 fatty acid docosahexaenoic acid and eicosapentaenoic acid.

8. The cryopreservation media of claim 1 wherein the cryopreservation media allows diffusion of the one or more cyroprotectant molecules into a plurality of cells added to the aqueous solution.

9. Cyroprotectant molecules, comprising:
naturally occurring or derived non-naturally occurring amphipathic phospholipid-derived phosphodiesters, including glycerophosphocholine (GPC), serine ethanolamine phosphodiester, glycerophosphoinositol or diphosphotriglycerol (G-P-G-P-G);
amphipathic osmolytes including betaine, taurine, and acetyl-L-camitine;
polyol sugars including myo-inositol and trehalose; and
polyunsaturated fatty acids including co-3 fatty acid docosahexaenoic acid and eicosapentaenoic acid.

10. The cyroprotectant molecules of claim 9 wherein the cryoprotectant molecules insert into specific regions of a cell membrane and thereby displace water molecules in those areas.

11. The cyroprotectant molecules of claim 9 wherein the specific regions include a cell membrane surface including proteins and glycolipids, phospholipid head group region or the hydrophobic hydrocarbon core.

12. The cyroprotectant molecules of claim 9 wherein the cyroprotectant molecules are mixed with a cryoprotectant media comprising an aqueous solution including varying mole fractions of one or more cryoprotectant molecules, pH adjustors, buffers, osmolarity adjustors and preservatives that are not toxic to a biological being preserved.

13. The cyroprotectant molecules of claim 9 wherein the cyroprotectant molecules protect against cellular membrane damage and aid in cell membrane repair when a cell is brought back to a normal temperature for cellular function.

14. A cryopreservation process for cryopreserving cells, comprising:
mixing a pre-determined quantity of one or more cryoprotectant molecules and a cryopreservation media into an aqueous solution;
immersing a plurality of cells in a pre-cryopreservation state into the aqueous solution for a predetermined amount of time depending on types of cells included in the plurality of cells;
slowly lowering the temperature of the aqueous solution for a pre-determined amount of time to a pre-determined temperature creating a frozen solution, thereby providing cryopreservation of the plurality of cells for later use.

15. The cryopreservation process of claim 14 wherein the one or more cryoprotectant molecules comprise:
naturally occurring or derived non-naturally occurring amphipathic phospholipid-derived phosphodiesters, including glycerophosphocholine (GPC), serine ethanolamine phosphodiester, glycerophosphoinositol or diphosphotriglycerol (G-P-G-P-G);
amphipathic osmolytes including betaine, taurine, and acetyl-L-carnitine;
polyol sugars including myo-inositol and trehalose; and
polyunsaturated fatty acids including ω-3 fatty acid docosahexaenoic acid and eicosapentaenoic acid.

16. The cryopreservation process of claim 14 wherein the cryopreservation media includes an aqueous solution with varying mole fractions of the one or more cryoprotectant molecules, pH adjustors, buffers, osmolarity adjustors and preservatives that are not toxic to the tissue being preserved.

17. The cryopreservation process of claim 14 wherein the immersing step includes a first pre-determined amount of time for immersing lower density plurality of cells such as cellular suspensions or tissues with immersion times from one minute to one hour duration.

18. The cryopreservation process of claim 14 wherein the immersing step includes a second pre-determined amount of time for immersing higher density plurality of cells including organs with immersion times from one hour to three hours.

19. The cryopreservation process of claim 14 wherein the pre-determined amount of time includes one to five hours.

20. The cryopreservation process of claim 14 wherein the pre-determined temperature includes a pre-determined temperature between zero ° C. and −196° C.

21. The cryopreservation process of claim 14 wherein the plurality of cells include human or other animal cells comprising stem cells; corneas; tissues of a cardiovascular system such as heart, blood, and blood vessels; tissues of a respiratory system such as lung tissue; tissues of a digestive system such as liver and pancreas tissues; tissues of a urinary tract such as kidney tissues; neural tissues; tissues of a musculoskeletal system such as tendon; tissues of the nervous system such as neurons and glia; or embryonic tissues.

22. The cryopreservation process of claim 14 wherein the plurality of cells include non-human cells comprising plant cells including bulbs, tubers, rhizomes, and embryos of plants.

23. The cryopreservation process of claim 14 further comprising:
slowly raising the temperature of the frozen solution for a pre-determined amount of time to a pre-determined temperature, thereby returning the plurality of cells to the pre-cryopreservation state without damaging the plurality of cells.
